(19) United States
(12) Patent Application Publication
(10) Pub. No.: US 2023/0276495 A1
(43) Pub. Date: Aug. 31, 2023

(54) CHANNEL OCCUPANCY BASED ON A PRIORITY

(71) Applicant: Lenovo (Singapore) Pte. Ltd., New Tech Park (SG)

(72) Inventors: Alexander Johann Maria Golitschek Edler von Elbwart, Darmstadt (DE); Hossein Bagheri, Urbana, IL (US); Joachim Loehr, Wiesbaden (DE)

(21) Appl. No.: 18/019,583

(22) PCT Filed: Aug. 3, 2021
(86) PCT No.: PCT/IB2021/057100

§ 371 Date: Feb. 3, 2023

Related U.S. Application Data
(60) Provisional application No. 63/060,516, filed on Aug. 3, 2020.

(51) Int. Cl. H04W 74/08; H04L 5/00; H04W 72/566

(52) U.S. Cl. CPC H04W 74/0808; H04L 5/0064; H04W 72/569; H04W 74/0875

(57) ABSTRACT

Apparatuses, methods, and systems are disclosed for channel occupancy based on a priority. One method includes determining, at a user equipment, a transmission priority for a transmission on a shared channel resource. The method includes comparing the transmission priority to a threshold priority. The method includes, in response to the transmission priority exceeding the threshold priority, initiating a channel occupancy for the transmission. The method includes, in response to the transmission priority not exceeding the threshold priority, not initiating the channel occupancy for the transmission.

### CROSS-REFERENCE TO RELATED APPLICATIONS

This application claims priority to U.S. patent application Ser. No. 63/060,516 entitled “APPARATUSES, METHODS, AND SYSTEMS FOR CRITERION FOR ALLOWING UE CHANNEL ACCESS” and filed on Aug. 3, 2020 for Alexander Johann Maria Golitschek Edler von Elbwart, which is incorporated herein by reference in its entirety.

### FIELD

The subject matter disclosed herein relates generally to wireless communications and more particularly relates to channel occupancy based on a priority.

### BACKGROUND

In certain wireless communications networks, resources for scheduled transmissions may overlap one another. Overlapping resources may interfere with one another.

### BRIEF SUMMARY

Methods for channel occupancy based on a priority are disclosed. Apparatuses and systems also perform the functions of the methods. One embodiment of a method includes determining, at a user equipment, a transmission priority for a transmission on a shared channel resource. In some embodiments, the method includes comparing the transmission priority to a threshold priority. In certain embodiments, the method includes, in response to the transmission priority exceeding the threshold priority, initiating a channel occupancy for the transmission. In various embodiments, the method includes, in response to the transmission priority not exceeding the threshold priority, not initiating the channel occupancy for the transmission.

One apparatus for channel occupancy based on a priority includes a user equipment. In some embodiments, the apparatus includes a processor that: determines a transmission priority for a transmission on a shared channel resource; compares the transmission priority to a threshold priority; in response to the transmission priority exceeding the threshold priority, initiates a channel occupancy for the transmission; and, in response to the transmission priority not exceeding the threshold priority, does not initiate the channel occupancy for the transmission.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for channel occupancy based on a priority;

FIG. 2 is a schematic block diagram illustrating one embodiment of an apparatus that may be used for channel occupancy based on a priority;

FIG. 3 is a schematic block diagram illustrating one embodiment of an apparatus that may be used for channel occupancy based on a priority;

FIG. 4 is a schematic block diagram illustrating one embodiment of a system having overlapping uplink resources for two UEs within a fixed frame period or channel occupancy;

FIG. 5 is a schematic block diagram illustrating one embodiment of a system having overlapping configured grant resources; and

FIG. 6 is a flow chart diagram illustrating one embodiment of a method for channel occupancy based on a priority.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

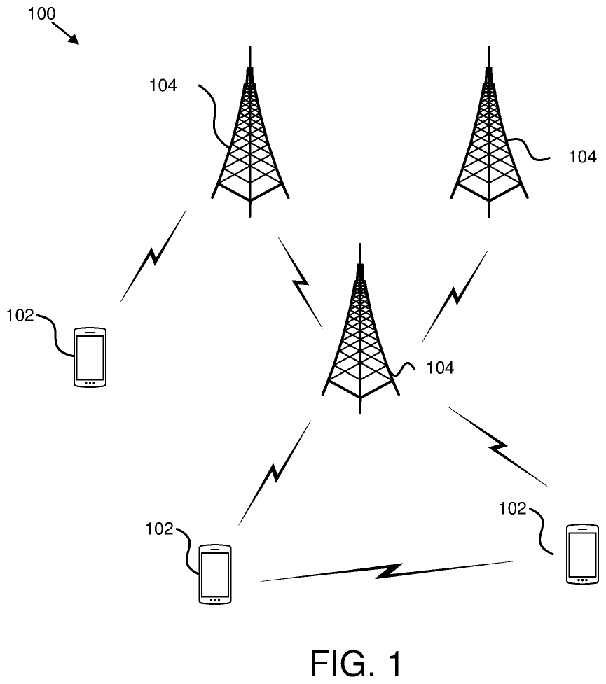

FIG. 1 depicts an embodiment of a wireless communication system 100 for channel occupancy based on a priority. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to and/or may include one or more of an access point, an access terminal, a base, a base station, a location server, a core network (“CN”), a radio network entity, a Node-B, an evolved node-B (“eNB”), a 5G node-B (“gNB”), a Home Node-B, a relay node, a device, a core network, an aerial server, a radio access node, an access point (“AP”), new radio (“NR”), a network entity, an access and mobility management function (“AMF”), a unified data management (“UDM”), a unified data repository (“UDR”), a UDM/UDR, a policy control function (“PCF”), a radio access network (“RAN”), a network slice selection function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with NR protocols standardized in third generation partnership project (“3GPP”), wherein the network unit 104 transmits using an OFDM modulation scheme on the downlink (“DL”) and the remote units 102 transmit on the uplink (“UL”) using a single-carrier frequency division multiple access (“SC-FDMA”) scheme or an orthogonal frequency division multiplexing (“OFDM”) scheme. More generally, however, the wireless communication system 100 may implement some other open or proprietary communication protocol, for example, WiMAX, institute of electrical and electronics engineers (“IEEE”) 802.11 variants, global system for mobile communications (“GSM”), general packet radio service (“GPRS”), universal mobile telecommunications system (“UMTS”), long term evolution (“LTE”) variants, code division multiple access 2000 (“CDMA2000”), Bluetooth®, ZigBee, Sigfoxx, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

In various embodiments, a remote unit 102 may determine a transmission priority for a transmission on a shared channel resource. In some embodiments, the remote unit 102 may compare the transmission priority to a threshold priority. In certain embodiments, the remote unit 102 may, in response to the transmission priority exceeding the threshold priority, initiate a channel occupancy for the transmission. In various embodiments, the remote unit 102 may, in response to the transmission priority not exceeding the threshold priority, not initiate the channel occupancy for the transmission. Accordingly, the remote unit 102 may be used for channel occupancy based on a priority.

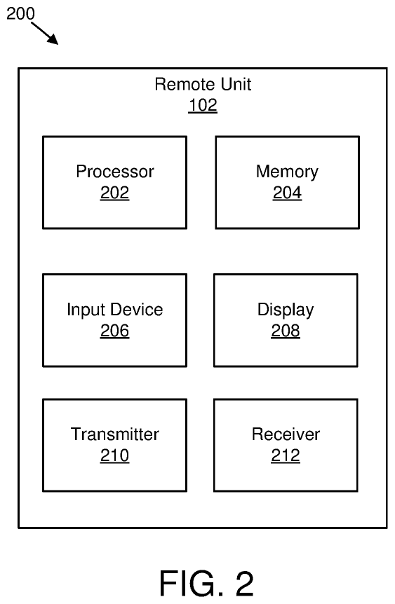

FIG. 2 depicts one embodiment of an apparatus 200 that may be used for channel occupancy based on a priority. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media.

In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, a liquid crystal display (“LCD”), a light emitting diode (“LED”) display, an organic light emitting diode (“OLED”) display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

In certain embodiments, the processor 202: determines a transmission priority for a transmission on a shared channel resource; compares the transmission priority to a threshold priority; in response to the transmission priority exceeding the threshold priority, initiates a channel occupancy for the transmission; and, in response to the transmission priority not exceeding the threshold priority, does not initiate the channel occupancy for the transmission.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

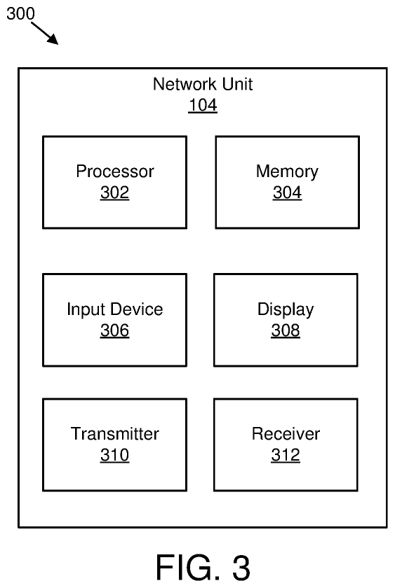

FIG. 3 depicts one embodiment of an apparatus 300 that may be used for channel occupancy based on a priority. The apparatus 300 includes one embodiment of the network unit 104. Furthermore, the network unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

In certain embodiments, such as for operation in an unlicensed spectrum (e.g., in a semi-static channel access-operation according to frame-based equipment (“FBE”)), downlink and uplink transmissions are allowed after a node such as a gNB or a user equipment (“UE”) has acquired the shared channel by a successful clear channel assessment following a listen-before-talk (“LBT”) procedure. In some embodiments, procedures for gNBs and UEs acquiring a channel occupancy time (“COT”) may be specified. However, it may be unknown how a UE may initiate a channel occupancy (“CO”) in a semi-static channel access.

In various embodiments, one motivation for a UE to initiate a CO is to reduce a latency of a configured grant physical uplink shared channel (“PUSCH”) transmission as a gNB may not be aware of whether there is any data to be transmitted by the UE and the gNB may not have any downlink (“DL”) or uplink (“UL”) data, control, and/or reference signals to schedule and/or transmit and may not intend to sense a channel to acquire a COT. In certain embodiments, allowing some UEs in a cell in certain conditions to initiate a CO instead of allowing all and/or many UEs to initiate a CO may have advantages such as allowing UEs to have latency sensitive data to transmit their UL data and/or control first by avoiding collision with other UEs that might have data and/or control that can tolerate some latency.

In certain embodiments relating to a UE-initiated CO (e.g., in the context of ultra-reliable low-latency communication (“URLLC”) operation in FBE mode) where a communication latency target is to be achieved, a UE is enabled to initiate a CO and may terminate an UL transmission burst.

It should be noted that as used herein, a symbol, a slot, a subslot, and/or a transmission time interval (“TTI”) may be a time unit with a particular duration (e.g., symbol could be a fraction and/or percentage of an orthogonal frequency division multiplexed (“OFDM”) symbol length associated with a particular subcarrier spacing (“SCS”)). Moreover, an UL transmission (e.g., UL transmission burst) may include multiple transmissions (e.g., of the same or with a different priority if a priority is associated with the transmissions) and there may be gaps between the transmissions. The gaps may be short enough in duration to not necessitate performing a channel sensing and/or LBT operation between the transmissions. Embodiments found herein may be applicable to configurations with configured resources, such as a configured grant (“CG”) mechanism as specified for a third generation partnership program (“3GPP”) new radio (“NR”) system, but may be applied to any shared channel resource such as physical downlink shared channel (“PDSCH”) or PUSCH resources.

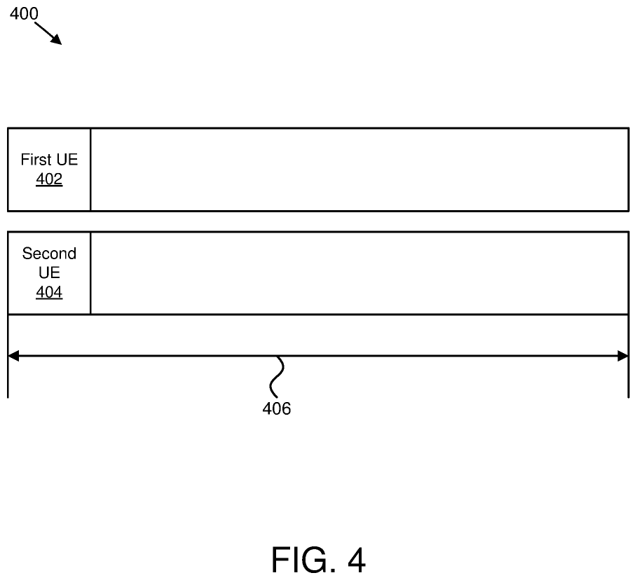

In certain embodiments, a UE may be allowed to access a channel and/or initiate a CO at various times. In some embodiments, allowing a limited set of UEs under certain conditions to initiate a CO instead of allowing a lot of UEs (or most UEs capable of UE CO initiation) to initiate a COT at the beginning of a frame period may have certain advantages. In one example, allowing UEs only with high priority (“HP”) data and/or control to initiate a CO may be useful to give them a chance to use the beginning of the CO to send their HP data and/or control. For instance, as shown in FIG. 4, assume that two UEs have overlapping configured grant resources so that both UEs would compete for access to the shared resource. Specifically, FIG. 4 is a schematic block diagram illustrating one embodiment of a system 400 having overlapping uplink grant resources for two UEs within a fixed frame period or channel occupancy—between a first UE 402 and a second UE 404 for data transmission over the beginning of a fixed frame period 406 (“FFP”). As an outcome of a clear channel assessment (“CCA”), it may happen that only one of the UEs detects the channel as idle while the other detects it as busy, so that only one of the UEs would transmit its data. In such conditions, there may be a high likelihood that the corresponding transmission may be received correctly. However, it may also happen that both UEs detect the channel as idle during their respective CCA procedure, so that both access the channel simultaneously, leading to collisions on the channel and consequently to a high likelihood that neither transmission may be received correctly. It may also happen that both UEs detect the channel as busy, so that neither will transmit.

In various embodiments, to decrease the likelihood of a collision of transmissions from different UEs, a UE that intends to access the channel compares its transmission priority to a first threshold level. The UE is allowed to access the channel if the determined transmission priority exceeds (e.g., exceeds or is equal to) a threshold level (e.g., threshold priority level), for example, if the determined transmission priority is higher (or higher or equal to) than the threshold level. It should be noted that a higher priority may be intended to be understood as logically higher, which, depending on numerical convention for representing priorities, may imply a higher numeric value or a lower numeric value than a threshold value. For example, according to one convention, a low priority value is associated with a high priority process, while according to another convention, a high priority value is associated with a high priority process. In embodiments described herein, it may be assumed that a high priority value is associated with a high priority process.

In certain embodiments, a threshold may be a value configurable by a gNB, such as in a UE-specific configuration structure. In one example, the threshold is configured and/or indicated per LBT bandwidth and/or serving cell or per group of LBT bandwidths and/or serving cells. In some embodiments, a transmission priority may be determined via a logical channel prioritization (“LCP”) procedure.

In certain embodiments, a transmission priority may be determined by a highest priority among priorities of a logical channels with data available that is multiplexed or may be multiplexed in a medium access control (“MAC”) protocol data unit (“PDU”) associated with a PUSCH resource and/or UL grant. In some embodiments, a UE may not generate a transport block (“TB”) if a determined transmission priority is found to be smaller than a configured threshold level. Since a UE is not allowed to access a channel if a determined priority is smaller than the threshold, the UE may not perform a complete LCP procedure but only may determine a highest priority logical channel (“LCH”) with data that would end up in the TB if performing the full LCP procedure (e.g., the UE may only perform a first step (e.g., or part of the first step) of a resource allocation procedure considering logical channel mapping restrictions).

In various embodiments, a UE may be allowed to access a channel if data to be transmitted corresponds to a retransmission of a transport block. In certain embodiments, a UE may be allowed to access a channel if there is data and/or a TB pending in a hybrid automatic repeat request (“HARQ”) buffer of an associated HARQ process due to a failed LBT for a previous transmission attempt.

In some embodiments, a UE applies a rule for checking if it is allowed to access a channel for if the UE is initiating a CO, such as if a resource is at a beginning of a fixed frame period (e.g., such as immediate beginning or after a time gap from the beginning, and the time gap does not necessitate performing an LBT and/or CCA operation) in a semi-static channel access operation, or if initiating a CO with or without involving a contention window in a channel access procedure, such as Type 1 or Type 2 UL channel access.

In various embodiments, a UE applies a rule for checking if it is allowed to access a channel if a corresponding transmission is to occur on resources that have been granted to the UE as a CG resource.

In certain embodiments, a UE stops a CO as soon as a determined transmission priority for pending transmissions does not exceed (or does not exceed or is equal to) a second threshold level. The second threshold level may be identical to the first threshold level (e.g., configured to have the same value), or be an identical configuration parameter.

In some embodiments, if a transmission priority, priority for a PUSCH resource, and/or priority for an UL grant (e.g., physical layer priority, phy-PriorityIndex, MAC priority, LCH priority) is lower than a priority threshold, a HARQ entity obtains a MAC PDU to transmit from a multiplexing and assembly entity (e.g., if any) and considers the identified HARQ process as pending (e.g., autonomous transmission or retransmission of a TB is triggered and/or performed in a subsequent transmission opportunity). In various embodiments, in a subsequent transmission occasion where a pending HARQ process can be transmitted (e.g., for configured uplink grants configured with cg-RetransmissionTimer), a UE may toggle a new data indicator (“NDI”) in associated CG uplink control information (“UCI”) (“CG-UCP”).

In certain embodiments, if a transmission priority, priority for a PUSCH resource, and/or priority for an UL grant (e.g., a physical layer priority, phy-Prioritylndex, MAC priority, LCH priority) is lower than a priority threshold, a UE considers the UL grant as a deprioritized grant.

In some embodiments, if a transmission priority, priority for a PUSCH resource, and/or priority for an UL grant (e.g., a physical layer priority, phy-Prioritylndex, MAC priority, LCH priority) is lower than a priority threshold, a UE does not perform CCA and/or LBT prior to a FFP containing configured grant resources associated with the UL grant.

In various embodiments, if a transmission priority, priority for a PUSCH resource, and/or priority for an UL grant (e.g., a physical layer priority, phy-Prioritylndex, MAC priority, LCH priority) is lower than a priority threshold, a UE assumes an LBT failure indication is received (e.g., virtual LBT failure) from lower layers. As such, autonomous transmission and/or retransmission of a TB pending in a HARQ buffer may be triggered and/or performed in a subsequent transmission occasion.

In certain embodiments, if a transmission priority, priority for a PUSCH resource, and/or priority for an UL grant is lower than a priority threshold (e.g., high priority data), a UE initiates a COT if a cg-RetransmissionTimer for a corresponding HARQ process is about to expire (e.g., timer value is smaller than a timing threshold) in a coming FFP or after a time offset from a beginning of the coming FFP. In some embodiments, a UE initiates a COT by autonomously retransmitting a TB associated with a HARQ process in a configured grant resource at a beginning of a coming FFP (e.g., earlier than expiry of a cg-RetransmissionTimer).

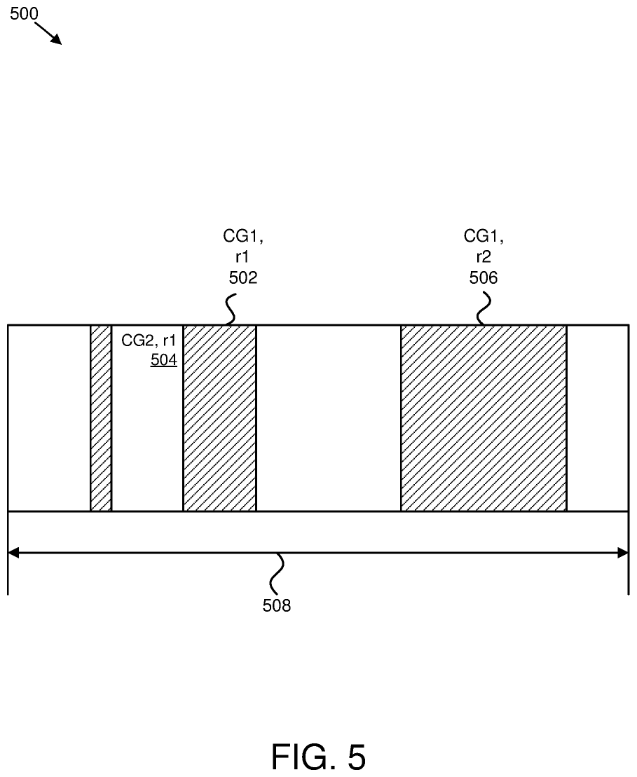

In various embodiments, in a shared spectrum operation (e.g., if a UE is configured with a semi-static channel access mode such as FBE), if PUSCH resources of at least two configured uplink grants (e.g., including a first configured UL grant and a second configured UL grant) with equal priorities, or exceeding a priority threshold, overlap at least partially, as exemplified in FIG. 5, a prioritized uplink grant is determined by one of the following schemes: 1) prioritize the configured uplink grant which has the lowest configured grant index among the overlapped configured grants; or 2) prioritize the configured uplink grant which has no additional configured grant resource instance after the current resource instance within the FFP, where a time duration to an end of the FFP after the current resource instance (e.g., including and/or excluding the idle period) is less than a threshold.

FIG. 5 is a schematic block diagram illustrating one embodiment of a system 500 having overlapping configured grant resources. Resource 1 of CG1 (e.g., CG1, r1 502) and resource 1 of CG2 (e.g., CG2, r1 504) overlap, and CG1 has another resource (e.g., CG1, r2 506) in the same FFP 508. There is no resource for CG2 after resource 1 of CG2 (e.g., CG2, r1 504). Because of the overlap of CG1, r1 502 and CG2, r1 504, a UL grant associated with CG2 is the prioritized uplink grant in resource r1.

In certain embodiments, overlapping resources are used and transmitted according to a prioritized uplink grant. In some embodiments, resources according to a non-prioritized uplink grant are not transmitted for a corresponding time unit. For example, CG1, r1 502 is not being used since it is non-prioritized while CG2, r1 504 is prioritized in the same time unit, and CG1, r2 506 is transmitted since there is no overlap in the same time unit.

In various embodiments, a UE indicates (e.g., via a capability signaling) a indication of whether the UE is capable of determining a priority of its transmission sufficiently ahead of time before an actual transmission. Determining the priority of the transmission, such as by LCP, may require a certain processing time that may depend on an actual implementation, processing capabilities, and so forth. In such embodiments, the determined priority may need to be known before the UE starts a CCA procedure. For example, for a CCA, the UE may need to receive or measure signals to determine whether the channel is idle or busy. This may block other reception activities, such as inter-frequency measurements or control channel receptions.

In certain embodiments, there may be a cut-off time prior to a transmission that allows procedures such as transport block generation, forward error correction encoding, modulation, digital to analog (“D/A”) conversion, and so forth to finish in time. The cut-off time prior to the transmission may be applicable for a determination of a transmission priority, and may be determined like a UE PUSCH preparation procedure time. This may be applied as follows: the determination of the transmission priority may be determined at or prior to the beginning of a symbol L2, where L2 is defined as a latest uplink symbol with its cyclic prefix (“CP”) starting T_priority before the first uplink symbol in the PUSCH allocation for a transport block, including the demodulation reference signal (“DM-RS”), and including the effect of the timing advance, where T_priority=maxƒ₀((N_2+d_2,1+d_2)(2048+144)κ2\hat{ }(−μ)·T_C+T_ext+T_switch,d_2,2), where the respective parameters and values may be obtained.

In some embodiments, for configured uplink grants, a HARQ process identifier (“ID”) associated with a first symbol of a UL transmission may be derived from the following equation: HARQ Process ID=[floor(CURRENT_symbol/periodicity)] modulo nrofHARQ-Processes+offset, where CURRENT_symbol=(SFN×numberOfSlotsPerFrame×numberOfSymbolsPerSlot+slot number in the frame×numberOfSymbolsPerSlot+symbol number in the slot), and numberOfSlotsPerFrame and numberOfSymbolsPerSlot refer to the number of consecutive slots per frame and the number of consecutive symbols per slot. If an offset is configured and/or indicated for a configured UL grant (e.g., such as a harq-ProcID-Offset or harq-ProcID-Offset2), a UE sets the offset according to a configured and/or indicated offset, or else the offset is set to zero. It should be noted that CURRENT_symbol refers to a symbol index of a first transmission occasion of a repetition bundle that takes place.

In various embodiments, if an UL transmission of a UE in a configured grant resource within a gap from a start of an FFP and/or from a previous UL and/or DL transmission, with the gap larger than the gap for which LBT and/or CCA is required, is prepended (e.g., via increasing CP length of the first symbol), the HARQ process ID associated with the UL transmission is determined according to the formula above (or a similar formula to the above formula), with “CURRENT_symbol” being determined based on a nominal first symbol of the UL transmission, and not based on the actual first symbol of the UL transmission, as prepending the UL transmission may lead to the actual first symbol of the UL transmission being a symbol that is prior to the first symbol of the configured grant resource (e.g., also referred to as nominal first symbol). In such embodiments, the UL transmission may be done without requiring the UE to perform LBT and/or CCA prior to the UL transmission, or it may be done performing LBT and/or CCA prior to the UL transmission with a fixed duration (e.g., such as Type 2) instead of with an exponentially increasing contention window (e.g., such as Type 1).

In certain embodiments, a UE prepends an UL transmission (e.g., associated with a configured grant configuration) if a HARQ process ID associated with the prepended UL transmission is among the HARQ process IDs available for transmission or among the HARQ process IDs associated with a configured grant configuration. In such embodiments, the UL transmission may be done without requiring the UE to perform LBT and/or CCA prior to the UL transmission (e.g., at the beginning of an FFP), or it may be done performing LBT and/or CCA prior to the UL transmission with a fixed duration (e.g., such as Type 2 LBT) instead of with an exponentially increasing contention window (e.g., such as Type 1 LBT).

In some embodiments, a UE prepends an UL transmission (e.g., associated with a configured grant configuration) if a configured uplink grant is configured with cg-RetransmissionTimer (e.g., autonomous retransmission). In such embodiments, the UL transmission may be done without requiring the UE to perform LBT and/or CCA prior to the UL transmission (e.g., at the beginning of an FFP), or it may be done performing LBT and/or CCA prior to the UL transmission with a fixed duration (e.g., such as Type 2 LBT) instead of with an exponentially increasing contention window (e.g., such as Type 1 LBT).

In various embodiments, a UE may prioritize retransmissions before initial transmissions of the same priority.

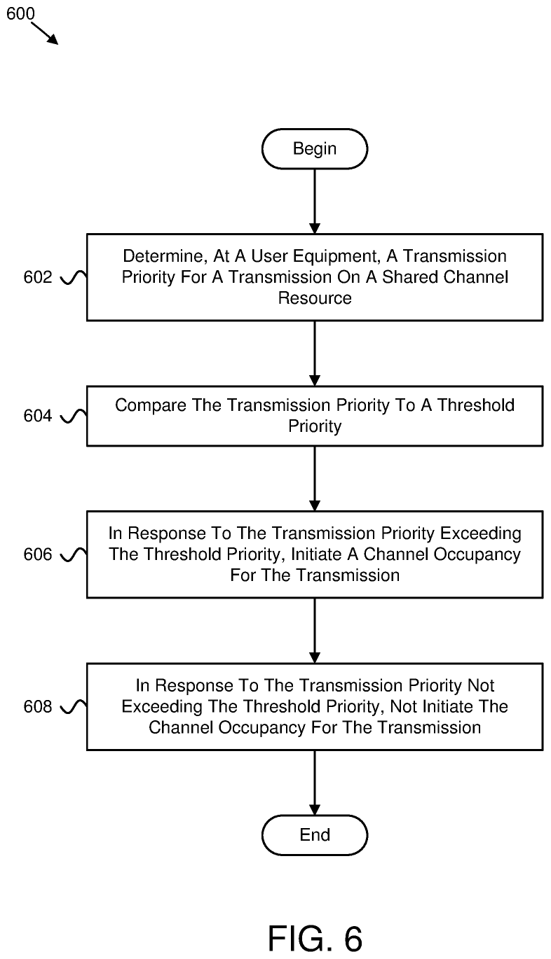

FIG. 6 is a flow chart diagram illustrating one embodiment of a method 600 for channel occupancy based on a priority. In some embodiments, the method 600 is performed by an apparatus, such as the remote unit 102. In certain embodiments, the method 600 may be performed by a processor executing program code, for example, a microcontroller, a microprocessor, a CPU, a GPU, an auxiliary processing unit, a FPGA, or the like.

In various embodiments, the method 600 includes determining 602, at a user equipment, a transmission priority for a transmission on a shared channel resource. In some embodiments, the method 600 includes comparing 604 the transmission priority to a threshold priority. In certain embodiments, the method 600 includes, in response to the transmission priority exceeding the threshold priority, initiating 606 a channel occupancy for the transmission. In various embodiments, the method 600 includes, in response to the transmission priority not exceeding the threshold priority, not initiating 608 the channel occupancy for the transmission.

In certain embodiments, the threshold priority is preconfigured by a radio resource control configuration parameter. In some embodiments, the transmission priority for the transmission on the shared channel resource is determined by a logical channel prioritization procedure for a new transport block.

In various embodiments, the transmission priority is determined based on a highest priority among priorities of logical channels with data available that are multiplexed or able to be multiplexed in a medium access control protocol data unit associated with a physical uplink shared channel resource, an uplink grant, or a combination thereof. In one embodiment, the transmission priority for the transmission on the shared channel resource is determined to exceed the threshold priority if the shared channel resource is used for a retransmission of a transport block.

In certain embodiments, the shared channel resource is a configured grant uplink resource. In some embodiments, the threshold priority comprises a second transmission priority of a second transmission for a second user equipment. In various embodiments, the transmission priority exceeding the threshold priority comprises a first configured grant index of the user equipment being lower than a second configured grant index of the second user equipment.

In one embodiment, the transmission priority exceeding the threshold priority comprises a configured grant instance of the user equipment being a last configured grant instance of the user equipment within a fixed frame period. In certain embodiments, the method 600 further comprises stopping the channel occupancy for the transmission in response to the transmission priority not exceeding a second threshold priority. In some embodiments, the second threshold priority is the same as the threshold priority.

In one embodiment, a method comprises: determining, at a user equipment, a transmission priority for a transmission on a shared channel resource; comparing the transmission priority to a threshold priority; in response to the transmission priority exceeding the threshold priority, initiating a channel occupancy for the transmission; and in response to the transmission priority not exceeding the threshold priority, not initiating the channel occupancy for the transmission.

In certain embodiments, the threshold priority is preconfigured by a radio resource control configuration parameter.

In some embodiments, the transmission priority for the transmission on the shared channel resource is determined by a logical channel prioritization procedure for a new transport block.

In various embodiments, the transmission priority is determined based on a highest priority among priorities of logical channels with data available that are multiplexed or able to be multiplexed in a medium access control protocol data unit associated with a physical uplink shared channel resource, an uplink grant, or a combination thereof.

In one embodiment, the transmission priority for the transmission on the shared channel resource is determined to exceed the threshold priority if the shared channel resource is used for a retransmission of a transport block.

In certain embodiments, the shared channel resource is a configured grant uplink resource.

In some embodiments, the threshold priority comprises a second transmission priority of a second transmission for a second user equipment.

In various embodiments, the transmission priority exceeding the threshold priority comprises a first configured grant index of the user equipment being lower than a second configured grant index of the second user equipment.

In one embodiment, the transmission priority exceeding the threshold priority comprises a configured grant instance of the user equipment being a last configured grant instance of the user equipment within a fixed frame period.

In certain embodiments, the method further comprises stopping the channel occupancy for the transmission in response to the transmission priority not exceeding a second threshold priority.

In some embodiments, the second threshold priority is the same as the threshold priority.

In one embodiment, an apparatus comprises a user equipment. The apparatus further comprises: a processor that: determines a transmission priority for a transmission on a shared channel resource; compares the transmission priority to a threshold priority; in response to the transmission priority exceeding the threshold priority, initiates a channel occupancy for the transmission; and, in response to the transmission priority not exceeding the threshold priority, does not initiate the channel occupancy for the transmission.

In certain embodiments, the threshold priority is preconfigured by a radio resource control configuration parameter.

In some embodiments, the transmission priority for the transmission on the shared channel resource is determined by a logical channel prioritization procedure for a new transport block.

In various embodiments, the transmission priority is determined based on a highest priority among priorities of logical channels with data available that are multiplexed or able to be multiplexed in a medium access control protocol data unit associated with a physical uplink shared channel resource, an uplink grant, or a combination thereof.

In one embodiment, the transmission priority for the transmission on the shared channel resource is determined to exceed the threshold priority if the shared channel resource is used for a retransmission of a transport block.

In certain embodiments, the shared channel resource is a configured grant uplink resource.

In some embodiments, the threshold priority comprises a second transmission priority of a second transmission for a second user equipment.

In various embodiments, the transmission priority exceeding the threshold priority comprises a first configured grant index of the user equipment being lower than a second configured grant index of the second user equipment.

In one embodiment, the transmission priority exceeding the threshold priority comprises a configured grant instance of the user equipment being a last configured grant instance of the user equipment within a fixed frame period.

In certain embodiments, the processor stops the channel occupancy for the transmission in response to the transmission priority not exceeding a second threshold priority.

In some embodiments, the second threshold priority is the same as the threshold priority.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method comprising:
determining, at a user equipment, a transmission priority for a transmission on a shared channel resource;
comparing the transmission priority to a threshold priority;
in response to the transmission priority exceeding the threshold priority, initiating a channel occupancy for the transmission; and
in response to the transmission priority not exceeding the threshold priority, not initiating the channel occupancy for the transmission.

2. The method of claim 1, wherein the threshold priority is preconfigured by a radio resource control configuration parameter.

3. The method of claim 1, wherein the transmission priority for the transmission on the shared channel resource is determined by a logical channel prioritization procedure for a new transport block.

4. The method of claim 1, wherein the transmission priority is determined based on a highest priority among priorities of logical channels with data available that are multiplexed or able to be multiplexed in a medium access control protocol data unit associated with a physical uplink shared channel resource, an uplink grant, or a combination thereof.

5. The method of claim 1, wherein the transmission priority for the transmission on the shared channel resource is determined to exceed the threshold priority if the shared channel resource is used for a retransmission of a transport block.

6. The method of claim 1, wherein the threshold priority comprises a second transmission priority of a second transmission for a second user equipment, the transmission priority exceeding the threshold priority comprises a first configured grant index of the user equipment being lower than a second configured grant index of the second user equipment, and the shared channel resource is a configured grant uplink resource.

7. The method of claim 1, wherein the transmission priority exceeding the threshold priority comprises a configured grant instance of the user equipment being a last configured grant instance of the user equipment within a fixed frame period.

8. An apparatus comprising a user equipment, the apparatus further comprising:
a processor that:
determines a transmission priority for a transmission on a shared channel resource;
compares the transmission priority to a threshold priority;
in response to the transmission priority exceeding the threshold priority, initiates a channel occupancy for the transmission; and
in response to the transmission priority not exceeding the threshold priority, does not initiate the channel occupancy for the transmission.

9. The apparatus of claim 8, wherein the threshold priority is preconfigured by a radio resource control configuration parameter.

10. The apparatus of claim 8, wherein the transmission priority for the transmission on the shared channel resource is determined by a logical channel prioritization procedure for a new transport block.

11. The apparatus of claim 8, wherein the transmission priority is determined based on a highest priority among priorities of logical channels with data available that are multiplexed or able to be multiplexed in a medium access control protocol data unit associated with a physical uplink shared channel resource, an uplink grant, or a combination thereof.

12. The apparatus of claim 8, wherein the transmission priority for the transmission on the shared channel resource is determined to exceed the threshold priority if the shared channel resource is used for a retransmission of a transport block.

13. The apparatus of claim 8, wherein the shared channel resource is a configured grant uplink resource.

14. The apparatus of claim 8, wherein the threshold priority comprises a second transmission priority of a second transmission for a second user equipment, and the transmission priority exceeding the threshold priority comprises a first configured grant index of the user equipment being lower than a second configured grant index of the second user equipment.

15. The apparatus of claim 8, wherein the transmission priority exceeding the threshold priority comprises a configured grant instance of the user equipment being a last configured grant instance of the user equipment within a fixed frame period.

16. The method of claim 1, wherein the shared channel resource is a configured grant uplink resource.

17. The method of claim 1, further comprising stopping the channel occupancy for the transmission in response to the transmission priority not exceeding a second threshold priority.

18. The method of claim 17, wherein the second threshold priority is the same as the threshold priority.

19. The apparatus of claim 8, wherein the processor stops the channel occupancy for the transmission in response to the transmission priority not exceeding a second threshold priority.

20. The apparatus of claim 19, wherein the second threshold priority is the same as the threshold priority.
